(19) United States
(12) Patent Application Publication
(10) Pub. No.: US 2026/0332328 A1
(43) Pub. Date: Oct. 22, 2026

(54) SYSTEM AND METHOD FOR RAN-COORDINATED UE-ENFORCED UPLINK CONGESTION MITIGATION FOR MISSION CRITICAL APPLICATIONS

(71) Applicant: Nokia Solutions and Networks Oy, Espoo (FI)

(72) Inventors: Edward Grinshpun, Murray Hill, NJ (US); Andrea Francini, Chapel Hill, NC (US); Catello Di Martino, Sao Paulo (BR); NAKJUNG CHOI, Murray Hill, NJ (US)

(21) Appl. No.: 19/643,331

(22) Filed: Apr. 9, 2026

Related U.S. Application Data
(60) Provisional application No. 63/789,873, filed on Apr. 16, 2025.

(51) Int. Cl. H04L 5/00; H04L 41/5019

(52) U.S. Cl. CPC H04L 5/0044; H04L 41/5019

(57) ABSTRACT

A network node may obtain location information associated with at least one network device, and uplink (UL) data traffic pattern information from the at least one network device over at least one wireless communication channel associated with at least one application executed by the at least one network device, calculate network performance information associated with the at least one wireless communication channel associated with the at least one network device for a future time period based on the location information and the UL data traffic pattern information, determine a packet scheduling template for each network device of the at least one network device based on the calculated SLA compliance information and the UL data traffic information, and transmit the packet scheduling template to each network device of the at least one network device.

### RELATED FIELD

Various example embodiments relate to methods, apparatuses, systems, and/or non-transitory computer readable media for providing radio access network (RAN)-coordinated user equipment (UE)-enforced uplink (UL) congestion mitigation for mission critical applications.

### BACKGROUND

A 5^{th} generation mobile network (5G) standard, referred to as 5G New Radio (NR), is being developed to provide higher capacity, higher reliability, and lower latency communications than the 4G long term evolution (LTE) standard.

With the deployment of 5G networks and other high-speed networks, there has been increased proliferation of network-enabled devices and/or applications, such as autonomous vehicles, robots, Internet of Things (IoT) devices, industrial sensors, network-enabled medical devices, etc., which have been adapted to take advantage of the higher capacity, higher reliability, and lower latency communications service.

One proposed implementation of 5G network capabilities is related to the field of wirelessly controlled Operational Technology (OT) machinery, cloud robotics, and/or other industrial wirelessly controlled devices, where the controller and/or control system of the OT machinery, etc., is located in a cloud network (e.g., a private network, a Wide Area Network (WAN), a core network, the Internet, etc.) and provides control instructions to the wirelessly controlled device, e.g., an autonomous mining drill, an autonomous ground vehicle (AGV), a robot, an actuator, an unmanned aerial vehicle (UAV), a sensor, etc.

### SUMMARY

At least one example embodiment is directed to a network node.

In at least one example embodiment, the network node may include memory storing computer readable instructions, and processing circuitry configured to execute the computer readable instructions to cause the network node to, obtain location information associated with at least one network device, and uplink (UL) data traffic pattern information from the at least one network device over at least one wireless communication channel associated with at least one application executed by the at least one network device, calculate network performance information associated with the at least one wireless communication channel associated with the at least one network device for a future time period based on the location information and the UL data traffic pattern information, calculate service level agreement (SLA) compliance information for the at least one application corresponding to the future time period based on the network performance information associated with the at least one wireless communication channel, determine a packet scheduling template for each network device of the at least one network device based on the calculated SLA compliance information and the UL data traffic information, and transmit the packet scheduling template to each network device of the at least one network device.

Some example embodiments provide that the packet scheduling template includes a plurality of time slots, each time slot of the plurality of time slots is associated with a respective application of the at least one application executed by the at least one network device, and the packet scheduling template causes the at least one network device to, transfer UL packets stored in an application queue associated with the respective application to a UL transmission queue during the time slot associated with the respective application, and transmit the UL packets stored in the UL transmission queue to a radio access network (RAN) node based on a UL transmission schedule obtained from the RAN node.

Some example embodiments provide that each time slot of the plurality of time slots is associated with a mission-critical (MC) application, a business-critical (BC) application, a non-MC/BC application, or a virtual empty queue.

Some example embodiments provide that the network node is further caused to calculate the SLA compliance information for the at least one application corresponding to the future time period by, predicting an SLA violation probability for the at least one application corresponding to the future time period based on the network performance information associated with the at least one wireless communication channel and the packet scheduling template, and in response to the SLA violation probability exceeding a threshold SLA violation probability, adjusting the packet scheduling template such that at least one additional time slot of the packet scheduling template is assigned to the at least one application whose SLA violation probability exceeds the threshold SLA violation probability in response to at least one time slot assigned to the virtual empty queue being available, or adjusting at least one setting associated with the at least one application whose SLA violation probability exceeds the threshold SLA violation probability.

Some example embodiments provide that the network node is further caused to determine the packet scheduling template by, determining a current transmission capacity of the least one wireless communication channel for the future time period based on the calculated network performance information associated with the at least one wireless communication channel, determining a total desired packet transmission rate for all of the at least one application corresponding to the future time period based on the calculated SLA compliance information for the at least one application, and assigning the time slots of the packet scheduling template to the at least one application queue based on the determined current transmission capacity and the total desired packet transmission rate.

Some example embodiments provide that the network node is further caused to determine the packet scheduling template by, determining the packet scheduling template using a Worst-Case Fair Weighted-Fair Queueing algorithm.

Some example embodiments provide that the network node is further caused to update the packet scheduling template based on at least one setting associated with the at least one application executed by the at least one network device.

Some example embodiments provide that the network node is further caused to update the packet scheduling template in response to a modification to the UL data traffic pattern information.

Some example embodiments provide that the network node is further caused to update the packet scheduling template in response to a modification to network resources allocated to the at least one wireless communication channel.

Some example embodiments provide that the at least one network device is a plurality of network devices, and the network node is further caused to synchronize time across the plurality of network devices.

Some example embodiments provide that the network node is further caused to perform the synchronization of time across the plurality of network devices by using at least one of: real time kinematics GPS synchronization, a precision time protocol, a per-network device time adjustment, or any combinations thereof.

Some example embodiments provide that the network node is further caused to use the per-network device time adjustment by determining a scheduling time alignment by comparing a time at which UL data was received from a desired network device of the plurality of network devices to a scheduled UL transmission time for the desired network device according to the packet scheduling template.

Some example embodiments provide that the network performance information includes at least one of: UL cell congestion information, UL network device channel metric information, UL latency information, UL throughput information, or any combinations thereof, associated with the at least one wireless communication channel for the future time period.

Some example embodiments provide that the network node is at least one of: a near-real time RAN intelligent controller (RIC), a non-real time RIC, a RAN node, a virtual RAN, a cloud RAN, or any combinations thereof.

At least one example embodiment is directed to a network device.

In at least one example embodiment, the network device may include memory storing computer readable instructions, and processing circuitry configured to execute the computer readable instructions to cause the network device to, transmit current location information to a network controller, execute a plurality of applications, each application of the plurality of applications associated with a wireless communication channel, receive a packet scheduling template from a network node, the packet scheduling template including a plurality of time slots, each time slot of the plurality of time slots associated with a respective application executed by the network device, transfer uplink (UL) packets stored in at least one application queue associated with the respective application to a UL transmission queue during the time slot associated with the respective application, and transmit the UL packets stored in the UL transmission queue to a radio access network (RAN) node based on a UL transmission schedule obtained from the RAN node.

Some example embodiments provide that each time slot of the plurality of time slots is associated with a mission-critical (MC) application, a business-critical (BC) application, a non-MC/BC application, or a virtual empty queue.

Some example embodiments provide that every time slot of the plurality of time slots corresponds to a same duration of time.

Some example embodiments provide that the network device further includes a plurality of application queues, each of the application queues corresponding to a respective application of the plurality of applications, the plurality of application queues including the at least one application queue.

Some example embodiments provide that the network device is further caused to, measure network performance information associated with the wireless communication channel, and transmit the measured network performance information to the network controller, the measured network performance information enabling the network node to generate the packet scheduling template.

Some example embodiments provide that the measured network performance information includes at least one of: current network resource allocation information, downlink (DL) channel quality measurement information, UL queuing latency information, or any combinations thereof.

At least one example embodiment is directed to a network node.

In at least one example embodiment, the network node may include means for obtaining location information associated with at least one network device, and uplink (UL) data traffic pattern information from the at least one network device over at least one wireless communication channel associated with at least one application executed by the at least one network device, calculating network performance information associated with the at least one wireless communication channel associated with the at least one network device for a future time period based on the location information and the UL data traffic pattern information, calculating service level agreement (SLA) compliance information for the at least one application corresponding to the future time period based on the network performance information associated with the at least one wireless communication channel, determining a packet scheduling template for each network device of the at least one network device based on the calculated SLA compliance information and the UL data traffic information, and transmitting the packet scheduling template to each network device of the at least one network device.

Some example embodiments provide that the packet scheduling template includes a plurality of time slots, each time slot of the plurality of time slots is associated with a respective application of the at least one application executed by the at least one network device, and the packet scheduling template causes the at least one network device to, transfer UL packets stored in an application queue associated with the respective application to a UL transmission queue during the time slot associated with the respective application, and transmit the UL packets stored in the UL transmission queue to a radio access network (RAN) node based on a UL transmission schedule obtained from the RAN node.

Some example embodiments provide that each time slot of the plurality of time slots is associated with a mission-critical (MC) application, a business-critical (BC) application, a non-MC/BC application, or a virtual empty queue.

Some example embodiments provide that the network node further includes means for calculating the SLA compliance information for the at least one application corresponding to the future time period by, predicting an SLA violation probability for the at least one application corresponding to the future time period based on the network performance information associated with the at least one wireless communication channel and the packet scheduling template, and in response to the SLA violation probability exceeding a threshold SLA violation probability, adjusting the packet scheduling template such that at least one additional time slot of the packet scheduling template is assigned to the at least one application whose SLA violation probability exceeds the threshold SLA violation probability in response to at least one time slot assigned to the virtual empty queue being available, or adjusting at least one setting associated with the at least one application whose SLA violation probability exceeds the threshold SLA violation probability.

Some example embodiments provide that the network node further includes means for determining the packet scheduling template by, determining a current transmission capacity of the least one wireless communication channel for the future time period based on the calculated network performance information associated with the at least one wireless communication channel, determining a total desired packet transmission rate for all of the at least one application corresponding to the future time period based on the calculated SLA compliance information for the at least one application, and assigning the time slots of the packet scheduling template to the at least one application queue based on the determined current transmission capacity and the total desired packet transmission rate.

Some example embodiments provide that the network node further includes means for determining the packet scheduling template by, determining the packet scheduling template using a Worst-Case Fair Weighted-Fair Queueing algorithm.

Some example embodiments provide that the network node further includes means for updating the packet scheduling template based on at least one setting associated with the at least one application executed by the at least one network device.

Some example embodiments provide that the network node further includes means for updating the packet scheduling template in response to a modification to the UL data traffic pattern information.

Some example embodiments provide that the network node further includes means for updating the packet scheduling template in response to a modification to network resources allocated to the at least one wireless communication channel.

Some example embodiments provide that the at least one network device is a plurality of network devices, and the network node further includes means for synchronizing time across the plurality of network devices.

Some example embodiments provide that the network node further includes means for performing the synchronization of time across the plurality of network devices by using at least one of: real time kinematics GPS synchronization, a precision time protocol, a per-network device time adjustment, or any combinations thereof.

Some example embodiments provide that the network node further includes means for using the per-network device time adjustment by determining a scheduling time alignment by comparing a time at which UL data was received from a desired network device of the plurality of network devices to a scheduled UL transmission time for the desired network device according to the packet scheduling template.

Some example embodiments provide that the network performance information includes at least one of: UL cell congestion information, UL network device channel metric information, UL latency information, UL throughput information, or any combinations thereof, associated with the at least one wireless communication channel for the future time period.

Some example embodiments provide that the network node is at least one of: a near-real time RAN intelligent controller (RIC), a non-real time RIC, a RAN node, a virtual RAN, a cloud RAN, or any combinations thereof.

At least one example embodiment is directed to a network device.

In at least one example embodiment, the network device includes means for, transmitting current location information to a network controller, executing a plurality of applications, each application of the plurality of applications associated with a wireless communication channel, receiving a packet scheduling template from a network node, the packet scheduling template including a plurality of time slots, each time slot of the plurality of time slots associated with a respective application executed by the network device, transferring uplink (UL) packets stored in at least one application queue associated with the respective application to a UL transmission queue during the time slot associated with the respective application, and transmitting the UL packets stored in the UL transmission queue to a radio access network (RAN) node based on a UL transmission schedule obtained from the RAN node.

Some example embodiments provide that each time slot of the plurality of time slots is associated with a mission-critical (MC) application, a business-critical (BC) application, a non-MC/BC application, or a virtual empty queue.

Some example embodiments provide that every time slot of the plurality of time slots corresponds to a same duration of time.

Some example embodiments provide that the network device further includes a plurality of application queues, each of the application queues corresponding to a respective application of the plurality of applications, the plurality of application queues including the at least one application queue.

Some example embodiments provide that the network device further includes means for, measuring network performance information associated with the wireless communication channel, and transmitting the measured network performance information to the network controller, the measured network performance information enabling the network node to generate the packet scheduling template.

Some example embodiments provide that the measured network performance information includes at least one of: current network resource allocation information, downlink (DL) channel quality measurement information, UL queuing latency information, or any combinations thereof.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates an example wireless system according to at least one example embodiment;

FIG. 2 illustrates a block diagram of an example network node and/or network device according to at least one example embodiment;

FIG. 3 is a transmission diagram illustrating an example method for providing RAN-coordinated UE-enforced UL congestion mitigation according to at least one example embodiment;

FIG. 4 is an example diagram of a packet scheduling template (PST) according to at least one example embodiment; and

FIG. 5 is an example graph illustrating the effects on SLA achieved by a PST scheduler according to at least one example embodiment.

### DETAILED DESCRIPTION

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

Various example embodiments will now be described more fully with reference to the accompanying drawings in which some example embodiments are illustrated.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments configured forth herein.

It will be understood that, although the terms first, second, and so on may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent”).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures illustrated in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be illustrated in block diagrams in order not to obscure the example embodiments in unnecessary detail. In other instances, well-known processes, structures and techniques may be illustrated without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, and/or a subprogram. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, and/or hardware description languages, in combination with hardware (e.g., software executed by hardware). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a service, a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, and/or data, may be passed, forwarded, or transmitted via any suitable means including memory sharing, message passing, token passing, and/or network transmission.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, or an application-specific integrated circuit (ASIC).

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

While the various example embodiments of the present disclosure are discussed in connection with the 5G wireless communication standard for the sake of clarity and convenience, the example embodiments are not limited thereto, and one of ordinary skill in the art would recognize the example embodiments may be modified and/or adapted to use other wireless communication standards, such as the 4G standard, a Wi-Fi standard, a future 6G standard, a future 7G standard, etc.

Various example embodiments are directed towards providing radio access network (RAN)-coordinated user equipment (UE)-enforced uplink (UL) congestion mitigation, particularly for mission critical (MC) and/or business critical (BC) applications, etc. An Operational Technology (OT) control system refers to a control system for wirelessly controlled OT machinery and/or OT equipment, or in other words, a wirelessly controlled device (WCD) and/or a UE device. Examples of the WCD may include a robot, an AGV, a UAV, a driller, a sensor, a video camera, etc., but are not limited thereto. A controller of the WCD is located on a network (e.g., a private network, a private wireless network, a cloud network, etc.), such as at an edge network node, at a core network node, etc., of the network, and transmits instructions to the WCD and/or receives feedback data from the WCD (e.g., sensor data, video data, etc.) over the network. In contrast to direct control systems where the controller is “onboard” the controlled device, physically connected to the controlled device, and/or within direct communication range of the controlled device, the WCD is controlled by a controller that is connected to the WCD over at least one network. Because the controller is transmitting and/or receiving data to/from the WCD over a network, the service level agreement (SLA) requirements (e.g., service level requirements (SLR), quality of service (QoS) requirements, etc.) such as latency, throughput, jitter, reliability (e.g., packet loss), survival time, and/or service availability, for the data communications may be stringent.

Further, the WCD and its respective network controller may execute one or more applications (e.g., OT applications, OT services, etc.) related to the control and/or operation of the WCD, such as an application directed towards controlling the driving of an autonomous vehicle, an application directed towards capturing video from a camera installed on the autonomous vehicle, an application directed towards a sensor installed on the autonomous vehicle, etc. Each of the applications may have different criticality levels and/or priority levels, such as Mission Critical (MC) applications, Business Critical (BC) applications, and/or non-MC applications (also referred to as non-MC/BC applications), and each of the different criticality levels may have different SLA requirements, SLRs, and/or QoS requirements (hereinafter collectively referred to as SLA requirements) corresponding to them.

For example, Enterprise vertical industries, like the mining industry, etc., may utilize Private Wireless Access (PWA) networks to operate a variety of MC, BC, and non-MC/BC applications. For example, an Enterprise vertical industry may desire and/or require the remote control operations of a large number of mobile and stationary machines, and may require uninterrupted operation of each of the machines, which in turn may require tight SLA requirements on the connecting RAN node to carry in the uplink direction a large number of individual MC/BC application flows with different SLA requirements, e.g., different low latency and/or variable high bitrate requirements, etc., as well as requiring the handling and/or servicing of other (non-MC) application flows.

Any SLA violations may lead to service interruptions (e.g., downtime) of BC and/or MC applications. Prolonged service interruptions of BC and/or MC networked applications may require stoppage of the autonomous business operation (e.g., stoppage of the WCD, etc.) until a human crew is dispatched and resolves the issue. Such stoppage is typically initiated to reduce and/or prevent human injuries and even loss of lives, reduce and/or prevent damage to the WCD and/or the environment, and may lead to significant loss of business revenue (potentially up to millions of dollars). In the mining industry use case, MC telemetry data generated by a variety of sensors and video cameras installed on the WCD may be and/or must be continuously uploaded to mission control (e.g., an OT control network node, etc.) from autonomously operating drillers, shovels, trucks, dozers, etc.

For example, Table 1 illustrates examples of wireless network requirements for mining-industry MC, BC, and non-MC applications.

TABLE 1

| | Typical | | | Latency | |
|---|---|---|---|---|---|
| Use case/application | Criticality | Throughput | | (max) | |
| Driver fatigue monitor | non MC | <256 | kbps | 500 | ms |
| Non-critical broadband comm on mining | non MC | >2 | Mbps | 100 | ms |
| site | | | | | |
| Mobile broadband to adjacent mining | non MC | >10 | Mbps | 100 | ms |
| communities | | | | | |
| Personal health monitoring | non MC | <64 | kbps | 60 | s |
| Smart metering | non MC | <64 | kbps | NA | |
| Belt conveyor monitoring | BC | <64 | kbps | 500 | ms |
| Non-critical IoT sensors comms | non MC | <64 | kbps | 500 | ms |
| Asset lifecycle optimization & | non MC | <64 | kbps | 500 | ms |
| maintenance (Analytics) | | | | | |
| Water quality monitoring | non MC | <64 | kbps | NA | |
| Access control systems | non MC | <64 | kbps | 100 | ms |
| Remote vehicle control with CCTV | MC | >3 | Mbps | 20 | ms |
| Mission Critical PTT/PTV | MC | <64 kbps | | 300 ms | |
| | | (voice) | | (voice) | |
| | | >512 kbps | | 100 ms | |
| | | (video) | | (video) | |
| Tailing dams monitoring with CCTV | MC | >512 | kbps | 100 | ms |
| Fleet Management/Dispatch systems | MC | <128 | kbps | 20 | ms |
| Personal location with wearables, GIS | MC | <64 | kbps | 30 | s |
| CCTV/HD with Video Analytics | BC | >5 | Mbps | 100 | ms |
| Critical IoT sensors comms | MC | <64 | kbps | 50 | ms |
| Drone systems inspection with streaming | BC | >512 | kbps | 20 | ms |
| Autonomous Haulage System (AHS) | MC | >512 | kbps | 20 | ms |
| Autonomous Drilling System (ADS) | MC | >6 | Mbps | 20 | ms |
| Autonomous Crane System (port) | MC | >6 | Mbps | 20 | ms |
| Electrical substations & generator | BC | >128 | kbps | 20 | ms |
| system monitor (Remote automation) | | | | | |
| AR/VR for maintenance and training | non MC | >5 | Mbps | 10 | ms |
| 4K video | BC | >20 | Mbps | 100 | ms |
| Proximity/Collision warning systems | MC | >128 | kbps | 5 | ms |
| (V2X via cellular ntw) | | | | | |
| Automation systems based on Time | BC | >128 | kbps | 2 | ms |
| sensitivity network (critical SCADA | | | | | |
| systems) | | | | | |
| Collaborative robotics | BC | >128 | kbps | 5 | ms |

However, stringent SLA requirements may cause extremely high resource strains on wireless communications systems. While there have been efforts to improve the quality of experience of OT applications, etc., by detecting network impairments and/or performance degradation at one application endpoint and/or application terminal (e.g., the WCD side and/or the UE side, etc.) and adapting their network traffic streams in response to the network limitations (e.g., reducing the frame rate and/or video resolution of video streams transmitted by the application endpoint and/or application terminal, reducing the speed of an autonomously vehicle, stopping an autonomous vehicle, etc.), these solutions are not ideal because they are reactive and not proactive, and only adapt after a degradation of performance has been observed. For some wireless control systems (e.g., OT systems), such as industrial wireless control, autonomous vehicle guidance, etc., such reactive corrective measures may be insufficient and may lead to increased performance dysfunctions, security concerns, and/or safety threats, such as an autonomous vehicle crashing, an industrial robot harming a human operator, etc., due to lack of control from the network controller.

For example, in the mining industry use case, multiple autonomous trucks may be served by the same cell (e.g., the same RAN node) and each of the autonomous trucks may send large volumes of uplink LiDAR/camera data at a constant high resolution. While all of the autonomous trucks are located and/or travel in cell service areas with good wireless channel conditions, the SLAs for each of the OT applications corresponding to the autonomous trucks are maintained. However, one or more trucks may experience wireless channel quality degradation, e.g., due to entering an area with low channel quality, or due to temporary shadowing and/or signal blocking by other machines, etc. For an autonomous truck with degraded wireless channel quality to maintain an SLA related to data throughput, the RAN node would need to start allocating a larger amount of wireless resources, such as Physical Resource Blocks (PRBs), etc., to compensate for the reduced data rate of the modulation and coding schemes imposed by the degraded wireless channel. If these extra wireless resources are not available because, for example, other MC/BC application sessions are operating which are served by the same cell, then throughput, latency, and/or packet-loss SLA violations will follow for the autonomous truck with degraded wireless channel quality.

A prolonged SLA violation for even a single autonomous truck may lead mission control to stop all autonomous machinery in the area for safety reasons, and may require human crews to be dispatched for recovery operations. Additionally, a typical operational response for autonomously guided vehicles to degraded network throughput and/or latency may be a reduction of the vehicle speed. Such slowing down of the truck with poor channel conditions may have the adverse effect of keeping the truck in the poor channel area for a longer time, therefore further prolonging the duration of the SLA violation.

Additionally, some reactive remedies to the network limitations, e.g., network congestion, etc., may not solve and/or may exacerbate the performance degradation of the WCDs. For example, an autonomous vehicle may transmit large volumes of UL data, such as MC and/or BC LiDAR, camera data, etc., and the autonomous vehicle may travel into a geographic area with poor wireless channel quality and/or may temporarily experience wireless channel quality degradation which prohibits the autonomous vehicle from transmitting the large volume of UL data in accordance with its SLA requirements, which results in an SLA violation. To remedy potential safety issues, the network controller may instruct the autonomous vehicle to slow down or stop moving in order to avoid a collision, but by slowing down or stopping the autonomous vehicle in the geographic area with poor wireless channel quality, the network controller may prolong the SLA violation. After the number of SLA violations and/or the length of an ongoing SLA violation exceeds an SLA threshold, the network controller may shut down the autonomous vehicle and require time-consuming and/or expensive human intervention to restart the autonomous vehicle and drive the autonomous vehicle to a location with sufficient wireless channel quality to meet the SLA requirements of the autonomous vehicle, etc. A common approach to remedy this situation is to greatly increase the amount of wireless resources provisioned to each WCD, or in other words to significantly overprovision radio and/or spectral resources for each WCD based on a worst-case scenario basis, but this approach may leave the network resources of the PWA network heavily underutilized most of the time, e.g., during good wireless conditions, and may add significant additional expense to the PWA network cost for the Enterprise due to the overprovisioning of wireless network equipment (e.g., the addition of more RAN nodes, base stations, repeaters, etc., to the PWA network).

Another example of network congestion causing degradation of channel conditions may involve a set of different MC/BC applications executed by the same WCD concurrently sending a multitude of “elephant” (e.g., very high volume) and “mice” (e.g., very low volume) uplink data traffic flows, with both types of flows presenting broad ranges of throughput and/or latency requirements. It is known that even under mild or no network congestion, mice flows may experience significantly increased packet latency in the presence of elephant flows, which translates into a much longer completion time for the small data transfers of the mice flows. This happens because data packets of mice flows that share the same UL transmission queue with data packets of elephant flows may easily find a large number of elephant-flow packets in front of them when they arrive to the shared queue. A similar problem may be experienced by all types of flows in the presence of a large number of synchronized mice flows, which collectively behave like an elephant flow.

The problem of elephant and mice flows is typically solved via so called multi-queue active queue management (AQM), where data packets of different types of flows are stored in separate queues. With such arrangement, the uplink scheduler of the wireless network must be made aware of the SLA requirements of each queue, and must provide fair treatment to each of the queues to satisfy their respective SLAs.

However, in order to satisfy the SLAs of all MC/BC uplink flows, the number of such queues with distinct throughput and/or latency SLA requirements needs to be quite large. For example, there may need to have separate “elephant queues” for each permutation of supported camera field of view (FoV) width and/or camera bit-rate encoding resolution with a corresponding camera-feed latency, etc., separate “elephant queues” for each permutation of LiDAR resolution and LiDAR-feed latency, and separate “mouse queues” for each permutation of significantly different sensor data volume and/or required latency, etc.

The 3GPP 5G standards defined the Ultra Reliable Low Latency Communication (URLLC) service, but its commercial implementations are not yet mature. It is not clear if and/or when URLLC deployments will become available for support of many URLLC DRBs per UE with the required range of throughput and latency guarantees.

As a consequence of the current and expected future limitations in the solution space, current WCDs, such as mining equipment, need to use existing 5G (and in some cases 4G) off-the shelf PWA RAN UL schedulers (e.g., cell schedulers, RAN schedulers, etc.) that only support a small number of Guaranteed Bit Rate (GBR) and non-GBR (Best Effort) DRBs per UE.

Having a large number of different-priority non-GBR DRBs per UE is not practical. Uplink scheduling rules to handle large numbers of non-GBR DRBs per UE with significantly different throughput volumes and latencies are not yet available in commercial deployments. Conversely, utilizing multiple GBR DRBs for support of high-volume traffic flows may easily lead to significantly increased probabilities of congestion onset and SLA violations whenever a WCD experiences channel quality degradation, etc.

Accordingly, an approach is desired to provide an interface between OT applications, e.g., WCDs, UEs, etc., and the network which enables the reduction of and/or elimination of SLA violations that are due to serving cell congestion, and/or to reduce and/or eliminate WCD stoppages due to prolonged SLA violations, etc. More specifically, one or more example embodiments are directed to systems, apparatuses, methods, and/or non-transitory computer readable media for providing RAN-coordinated UE-enforced UL congestion mitigation for applications, such as mission critical applications, business critical applications, etc. One or more example embodiments enable the use of an “off-the-shelf” RAN UL scheduler (e.g., cell scheduler, etc.) without modifying the behavior of the off-the-shelf RAN UL scheduler, so that one or more example embodiments may be applied to not only new PWA network equipment, but also may be retroactively applied to existing 4G/5G PWA network equipment and/or network deployments, etc.

While the example embodiments are discussed in connection with an autonomous ground vehicle, the example embodiments are not limited thereto, and for example, one or more aspects of the example embodiments may be applied to controlling robot movement and/or robot traffic in a warehouse facility, controlling actuators and/or other mechanically operated devices, controlling sensors and/or security devices, UAVs, etc.

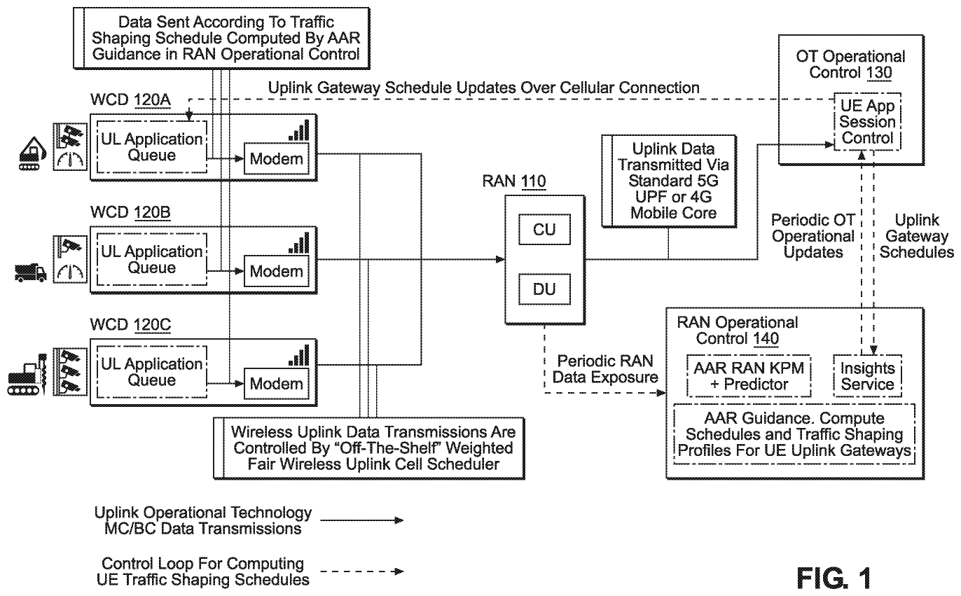

FIG. 1 illustrates an example wireless system according to at least one example embodiment. As shown in FIG. 1, a wireless communication system may include a radio access network (RAN) node 110, at least one wirelessly controlled device (e.g., WCD, a user equipment (UE) device or UE, OT machinery, etc.) 120A to 120C, an OT control network node 130, and/or a RAN operational control network node 140, etc., but the example embodiments are not limited thereto, and for example, may include a greater or lesser number of constituent elements. For example, the wireless communication system may include two or more RAN nodes, two or less WCDs, four or more WCDs, additional base stations, servers, routers, access points, gateways, etc.

The RAN node 110 and the WCD 120A to 120C may be connected over at least one wireless network, such as a cellular wireless access network (e.g., a 3G wireless access network, a 4G-Long Term Evolution (LTE) network, a 5G-New Radio (e.g., 5G) wireless network, a 6G wireless network, a 7G wireless network, a WiFi network, etc.). The wireless network may include a core network (not shown) and/or a Data Network (not shown). The RAN node 110 may connect to other RAN nodes (not shown), as well as to the core network and/or the Data Network, over a wired and/or wireless network. The Data Network may refer to the Internet, an intranet, a wide area network, etc.

According to some example embodiments, the RAN node 110 may act as a relay node (e.g., an integrated access and backhaul (IAB) node) and may communicate with the WCDs 120A to 120C, etc., in combination with at least one base station (and/or access point (AP), router, transmission/reception point (TRP), etc.) (not shown) of the same or a different radio access technology (e.g., WiFi, etc.). According to other example embodiments, the wireless communication system may further include at least one OT control network node 130 and at least one RAN operational control node 140, and data may be transmitted between one or more of the WCDs 120A to 120C, the RAN operational control network node 140, and/or the OT control network node 130, etc., via the RAN node 110, but the example embodiments are not limited thereto.

According to some example embodiments, the OT control network node 130 may be a controller, a network controller, an OT controller, a cloud controller, etc., of one or more of the WCD 120A to 120C, and in example embodiments where there are a plurality of WCDs 120A to 120C, a single OT control network node 130 may control a single WCD, two or more WCDs, all of the WCDs, etc., and/or the control of the plurality of WCDs 120A to 120C may be split among a plurality of OT control network nodes 130, but the example embodiments are not limited thereto.

For example, the OT control network node 130 may control mission and/or business logic of operations of one or more of the WCD 120A to 120C, etc., using one or more applications associated with the specific WCD 120A to 120C, etc. The OT control network node 130 may execute control loops corresponding to the application(s) for one or more of the WCD 120A to 120C based on one or more OT control variables, such as the type of at least one task or operation to be performed by the respective WCD 120A to 120C, the current status of the task to be completed by the respective WCD 120A to 120C, sensor data associated with the respective WCD 120A to 120C, the current location and/or predicted future locations of the respective WCD 120A to 120C, the current and/or predicted future movement speed of the respective WCD 120A to 120C, the amount of data to be uploaded by the respective WCD 120A to 120C, current and/or predicted future network conditions of at least one UL wireless communication channel associated with the respective WCD 120A to 120C, the SLA associated with the at least one UL wireless communication channel associated with the respective WCD 120A to 120C and/or the SLA associated with the task being performed by the respective WCD 120A to 120C, etc., but the example embodiments are not limited thereto. The time period for the execution of the control loop may range from a few milliseconds to several minutes, but the example embodiments are not limited thereto, and according to some example embodiments, the OT control network node 130 may dynamically change and/or adjust the OT operational control (e.g., instructions, commands, etc.) based on one or more of the OT control variables, etc.

For example, the OT operational control 130 may include a cognitive digital mine (CDM) endpoint controller (not shown) which may allow the OT control network node 130 to directly and/or indirectly control operations of functions hosted by a CDM endpoint (not shown) installed on, for example, WCD 120A, but is not limited thereto. The OT operational control 130 may also handle a communication protocol between the WCD 120A by, for example, assigning a unique identifier for communications from the WCD 120A. For example, the OT operational control 130 may define at least one unique identification pulse profile (IPP) to identify data traffic originating from the WCD 120A over a desired and/or specific wireless communication channel assigned to one or more control applications of the WCD 120A, such as at least one Data Radio Bearer (DRB) assigned to the one or more control applications, but the example embodiments are not limited thereto. According to at least one example embodiment, the IPP may be a unique data burst transmission pattern (e.g., a desired data burst sequence, etc.) over a desired time interval, such as transmitting desired amounts of data over a plurality of subintervals of the desired time interval. For example, an IPP assigned to a first wireless communication channel (e.g., a first DRB) for a first control application of the WCD 120A may include a unique data burst pattern of transmitting 1 MB of data over a first subinterval of 10 ms, transmitting 0 MB of data over a second subinterval of 10 ms, and transmitting 2 MB of data over a third subinterval of 10 ms, etc., but the example embodiments are not limited thereto. The IPP assigned for each wireless communication channel may be registered with the RAN operational control network node 140 and may allow the RAN operational control network node 140 to determine which wireless communication channel has been assigned to which control application of the WCD 120A and process the data packets transmitted on the wireless communication channel using the proper SLA requirements, etc.

Additionally, or alternatively, according to some example embodiments, data traffic associated with a particular control application and WCD combination may be identified by other methods, such as using a unique identifier included in a header and/or metadata of the data packets for identification purposes, etc., but are not limited thereto.

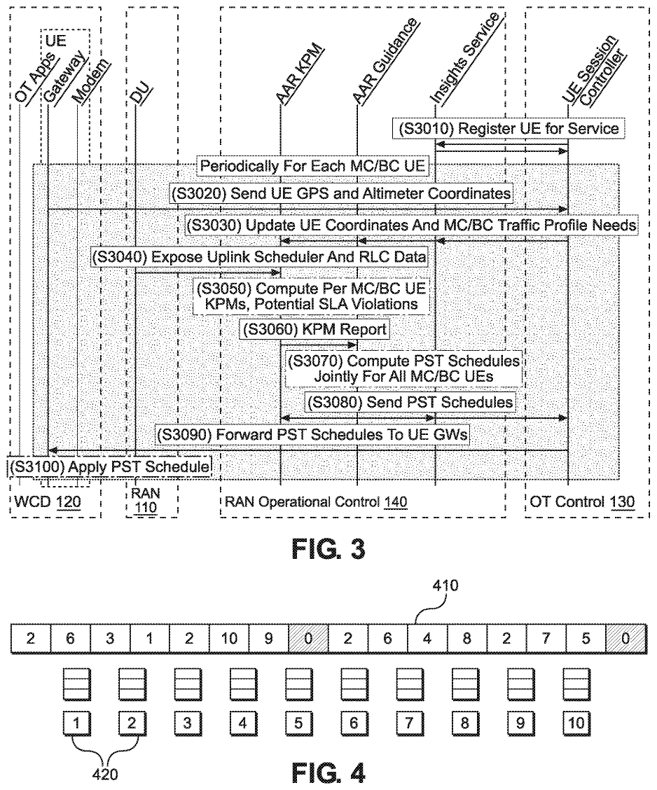

Further, the OT operational control 130 may act as dispatcher and/or intermediary in communications between the OT functions (e.g., OT applications, control applications, etc.) and/or one or more network functions of the core network with the WCD 120A, etc. The OT operational control 130 may also receive sensor data and/or telemetry data, WCD-measured network performance information (e.g., UL channel quality information, current network resource allocation information, downlink (DL) channel quality measurement information, UL queuing latency information, etc.), location information (e.g., GPS coordinates, altimeter coordinates, etc.) of the WCD 120A, and may distribute the data to other OT control functions, such as a UE application session control service, and/or other network functions, but is not limited thereto. The UE application session control service will be discussed in further detail in connection with FIG. 3.

Additionally, the OT operational control 130 may receive information related to the network from the RAN operational control network node 140, such as network performance information associated with one or more wireless communication channels, such as UL cell congestion information, UL network device channel metric information, UL latency information, UL throughput information, etc., but is not limited thereto. The OT operational control 130 may further perform dynamic network planning based on one or more of the inputs, such as providing network recommendations regarding the relocation of mobile cell unit(s), the relocation of WCDs, changes in coverage provision by, e.g., drone-based RAN nodes, etc., based on the current network usage and/or predicted future network usage by the WCDs under the control of the OT operational control 130, but the example embodiments are not limited thereto.

According to some example embodiments, the WCD 120A to 120C may be wirelessly controlled devices, such as, but not limited to, Internet of Things (IoT) devices, sensors (e.g., thermometers, humidity sensors, pressure sensors, motion sensors, accelerometers, etc.), actuators, robotic devices, drones, connected medical devices, eHealth devices, smart city related devices, security cameras, autonomous devices (e.g., autonomous vehicles, autonomous mining drills, etc.), and/or any other type of stationary or portable device capable of operating according to, for example, the 5G NR communication standard, and/or other wireless communication standard(s).

Additionally, in some example embodiments, the wireless network may further include additional UE devices, such as a smartphone, a tablet, a desktop computer, a laptop computer, a wearable device, etc., but the example embodiments are not limited thereto. The WCD 120A to 120C may be configurable to transmit and/or receive data in accordance to strict latency, reliability, and/or accuracy requirements, such as URLLC communications, TSC communications, etc., but is not limited thereto.

The WCD 120A to 120C may each have a CDM endpoint (not shown) installed and/or included, and/or may include processing circuitry and/or memory for performing operational control, commands, instructions received from a controller included in the OT control network node 130 and/or may operate autonomously, but the example embodiments are not limited thereto. For example, the WCD 120A may include a UL gateway, at least one UL application queue (e.g., application queue, UL gateway queue, etc.), etc., but is not limited thereto. The UL gateway may provide connectivity to the wireless network (e.g., RAN node 110, etc.) for the WCD, and may include local wired and/or wireless connections to equipment and/or sensors installed on the WCD, such as video cameras, etc., which may measure and/or provide OT telemetry data for use by the relevant OT control application, etc. Additionally, according to at least one example embodiment, the WCD 120A may further include a UL transmission scheduler (not shown), the UL transmission scheduler (e.g., UL scheduler, etc.) controlling the scheduling of a plurality of application queues (e.g., UL gateway queues, UL queues, etc.) which store data packets waiting to be transmitted from the UL gateway to a modem of the WCD before being transmitted to the RAN node 110 over at least one wireless communication channel. Each application queue of a particular WCD, e.g., WCD 120A, may correspond to a separate MC, BC, and/or non-MC/BC application session associated with the WCD 120A. This separation allows for the scheduling of data packet transmissions out of the queues based on the respective application SLA requirements, and therefore further reduce and/or eliminate the probability of an SLA violation for MC and/or BC applications. According to some example embodiments, the number of application queues corresponds to and/or is based on the number of MC and/or BC UL transmission flows (and/or groups of UL transmission flows) with distinct SLA requirements (e.g., network throughput, latency, packet-loss, etc., SLA requirements), but the example embodiments are not limited thereto.

The UL transmission scheduler may operate in a nonwork-conserving fashion, e.g., not scheduling the transmission of a UL data packet even if there is at least one application queue with queued packets, etc., and therefore may be referred to as a traffic shaper, but is not limited thereto. The UL transmission scheduler may transmit data packets to the respective modem based on a packet scheduling template (PST) (e.g., a traffic shaping template, etc.) generated by, for example, the RAN operational control network node 140, but the example embodiments are not limited thereto. The PST may include a periodic sequence of timeslots of identical time duration, wherein each timeslot represents a time interval that is dedicated to the transmission of data packets out of a single UL application queue, but the example embodiments are not limited thereto, and for example, the time durations for the timeslots may be different, etc. One of the queues of the WCD 120A may be referred to as a virtual empty queue (e.g., a dummy queue, a NULL queue, etc.) and may never store MC and/or BC-related data packets, and for example, may be always empty, or may be dedicated for the transmission of non-MC/BC data packets, etc. The PST will be discussed in greater detail in connection with FIGS. 3 to 5. According to some example embodiments, the PST of the UL transmission scheduler may be generated using a Worst-Case Fair Weighted-Fair Queueing (WF2Q) algorithm for assigning timeslots to the UL application queues according to their reserved service rates, under the assumption that all UL application queues always have packets to transmit and all packets have identical size, but the example embodiments are not limited thereto, and for example, other algorithms may be implemented. Consequently, the variations in packet inter-transmission times for the individual UL application queues may be decreased and/or minimized.

The WCD 120A may further uniquely identify data traffic corresponding to a particular control application UL flow by using an IPP received from and/or assigned by the OT operational control network node 130, by transmitting a unique data burst transmission pattern in accordance with the IPP assigned to at least one wireless communication channel (e.g., at least one DRB, etc.) used for the control application UL flow. The WCD 120A may monitor, measure, and/or compute UE-side key performance metrics (KPMs) (e.g., network device-side KPMs, etc.), such as network resource allocation information (e.g., the PRB allocation, etc.), DL channel quality measurements, UL queuing latency, etc., but is not limited thereto. The WCD 120A may further generate UE side KPM predictions corresponding to a desired future time period corresponding to predicted future location information of the WCD 120A based on the current location information and network information, and may provide the KPM predictions to the RAN operational control network node 140 and/or the OT control network node 130, etc., via signaling messaging, etc.

The wireless communication system further includes a plurality of TRPs (e.g., a base station, a wireless access point, etc.), such as RAN node 110, etc. The RAN node 110 may operate according to an underlying cellular and/or wireless radio access technology (RAT), such as 5G NR, LTE, Wi-Fi, etc., and may provide wireless network services to one or more WCDs and/or other UE devices within one or more cells (e.g., cell service areas, broadcast areas, serving areas, coverage areas, etc.) surrounding the respective physical location of the RAN node. For example, the RAN node 110 may be a node B (NodeB or NB), an evolved NodeB (eNodeB or eNB), a next generation node B (gNB), a Remote Radio Unit (RRU), a remote radio head (RRH), a relay, an Integrated Access and Backhaul (IAB) node, a low-power node. The RAN node 110 may be deployed in non-terrestrial network (NTN) devices, such as satellites (e.g., low earth orbit (LEO) satellites or geosynchronous earth orbit (GEO) satellites), aircrafts, or drones, where such NTN devices form a non-terrestrial network such as a ground station, or the RAN node 110 may also be deployed on the group in which case the RAN nodes may be referred to as terrestrial network device. A RAN node 110 comprising terrestrial network devices is generally referred to as a terrestrial network.

The RAN node 110 may have a split architecture where functions of the RAN node (e.g., an eNB or a gNB) are split between various entities. The RAN node 110 that has a split architecture may comprise a radio unit (RU) (otherwise referred to as a remote radio read (RRH), a centralized unit (CU) and one or more distributed units (DUs). A DU may be connected to an RU via a fronthaul. A DU may be connected to a CU via a midhaul or F1 interface. A CU may be connected to a core network via a backhaul. In some example embodiments, the RAN node 110 may have a split architecture, wherein operations of the RAN node may be carried out by the CU or the DU. For example, one CU may control one or more DUs, but the example embodiments are not limited thereto.

An RU converts radio signals sent to and from an antenna into a digital signal for transmission over a packet network, handles the digital front end (DFE) and the lower PHY layer, and includes digital beamforming functionality. A DU is a logical entity (e.g., software) that is hosted and run on a server located near an RU. A CU is a logical entity (e.g., software) that is hosted and run on a server. The CU may be hosted and run on its own server or may be hosted and run on the same server that hosts and runs the DU. The DU includes a subset of the functions of a RAN node (e.g., eNB or gNB, etc.) depending on the split of functions and the CU includes the other functions of a RAN node that are not in the subset of functions of the DU. A DU may comprise a subset of the layers of a protocol stack of a RAN node and a CU may comprise the other layers of the protocol stack that are not in the subset of layers in the DU. For example, in some implementations, a DU may include a radio link control (RLC) layer, a medium access control (MAC) layer and a physical (PHY) layer of a protocol stack for a RAN node, whereas a CU may comprise the layers of the protocol stack of a RAN node above the RLC layer, such as a packet data convergence protocol (PDCP) layer, a radio resource control (RRC) layer and an internet protocol (IP) layer. The operations of a DU are controlled by a CU.

Additionally, the RAN node 110 may be configured to operate in a multi-user (MU) multiple input multiple output (MIMO) mode and/or a massive MIMO (mMIMO) mode, wherein the RAN node 110 transmits a plurality of beams (e.g., radio channels, data streams, streams, etc.) in different spatial domains and/or frequency domains using a plurality of antennas (e.g., antenna panels, antenna elements, an antenna array, etc.) and beamforming and/or beamsteering techniques. For example, RAN node 110 may transmit and/or receive transmissions using two or more beams, but the example embodiments are not limited thereto, and for example, the RAN node may transmit using a greater or lesser number of beams, etc.

Additionally, WCD 120A to 120C may be located within a cell service area corresponding to the RAN node 110, and may connect to, receive broadcast messages from, receive paging messages from, receive/transmit signaling messages from/to, and/or access the wireless network through the RAN node 110. However, the example embodiments are not limited thereto, and for example, one or more of the WCDs 120A to 120C may connect to two or more RAN nodes and may perform carrier aggregation using one or more component carriers (CCs) from one or more of the RAN nodes, etc.

According to at least one example embodiment, the WCD 120A to 120C may include multiple antenna panels (e.g., may be a multi-panel UE device, etc.), and may transmit and/or receive to a plurality of RAN nodes (e.g., TRPs), etc., using the same time-frequency resources and/or using resources overlapping in time, but the example embodiments are not limited thereto.

According to at least one example embodiment, the RAN node 110 may be connected to at least one core network element (not shown) residing on the core network, such as a core network device, a core network server, access points, switches, routers, nodes, etc., but the example embodiments are not limited thereto. The core network may be implemented as a mobile core (e.g., a mobile core network, a mobile core network device, a mobile core network element, etc.), and may provide one or more network functions, such as a user plane function (UPF), an access and mobility management function (AMF), a session management function (SMF), a policy control function (PCF), a unified data management (UDM), an authentication server function (AUSF), an application function (AF), and/or a network slice selection function (NSSF), etc., and/or equivalent functions, but the example embodiments are not limited thereto.

Additionally, according to some example embodiments, a RAN operational control network node 140 may provide operational control of the wireless network and/or the RAN node 110 based on predictions related to network conditions and/or network workload received from the RAN node 110 and/or the WCDs 120A to 120C, and/or predictions related to the operation of the WCDs 120A to 120C received from the OT control network node 130 and/or the WCDs 120A to 120C, etc. For example, the RAN operational control network node 140 may include one or more of an application aware RAN (AAR) insight service (e.g., AAR insight interface, etc.), an AAR RAN KPM predictor, an AAR Guidance service, etc., but is not limited thereto.

The RAN operational control network node 140 may receive data exposed from the CU/DU of the RAN node 110, such as wireless communication channel resource scheduler information (e.g., DRB scheduler information), radio link control (RLC) information, etc., as well as data for specific OT control applications transmitted over the designated wireless communication channel assigned to the OT control applications. The AAR insight service of the RAN operational control network node 140 may receive registration information for MC and/or BC applications from the OT control network node 130 and/or one or more of the WCDs 120A to 120C, receive updates from the OT control network node 130 and/or one or more of the WCDs 120A to 120C after RAN mobility events cause changes in an SLA traffic profile to occur, etc. The AAR insight service may also generate and provide network-side KPMs, SLA compliance information (e.g., SLA violation probability information, SLA violation notifications, etc.), and/or other QoS traffic pattern and/or QoS information, that may be used by the OT control network node 130 and/or one or more of the WCDs 120A to 120C, etc. The AAR insight service may also receive the IPP registration information which enables the RAN operational control network node 140 to identify, index, and/or filter for data packets transmitted over a wireless communication channel (e.g., DRB, etc.) for a desired OT control application, etc. The IPP registration information may include SLA information (e.g., an SLA profile, SLA requirements, etc.) for the wireless communication channel, etc., which may be used by the RAN operational control network node 140 to enforce and/or comply with the SLA requirements for the associated WCD data traffic (e.g., MC data traffic, BC data traffic, and/or non-MC/BC data traffic, etc.), by adjusting priority for the different types of data traffic based on the SLA requirements, adjusting network resources allocated to the WCD for the MC data traffic and/or BC data traffic, etc.

The AAR RAN KPM predictor may monitor and/or predict network-side performance information (e.g., network-side KPMs), such as UL cell congestion information, UL network device channel metric information, UL latency information, UL throughput information, etc., of the wireless communication channel(s) carrying MC/BC data traffic, may monitor and/or predict SLA information (e.g., SLA violations, the probability of an SLA violation, etc.), etc., and may provide such data to the OT control network node 130, etc.

The AAR Guidance service may adjust, improve, and/or optimize network resource allocations to the wireless communication channel(s) (e.g., the DRBs, etc.) carrying MC/BC application traffic based on the registered SLA profiles associated with each MC and/or BC application. According to at least one example embodiment, the AAR Guidance service may dynamically adjust network resource allocations and/or scheduling for the relevant wireless communication channel based on the SLA requirements and current network conditions and predicted future network conditions, etc.

For example, in the case of six autonomous trucks (e.g., WCDs, UEs, etc.) being served by the same RAN node 110, each of the trucks may send high-volume video and/or LiDAR data at a frequency of 25 frames per second which corresponds to 40 ms per frame. Due to temporary degradation of UE channel quality, a UE transmission scheduler of the RAN node 110 may only be capable of providing PRBs sufficient enough to avoid SLA violations to only five trucks in each frame interval. If the UE transmission scheduler schedules all six trucks to send data at the same rate, it may cause all six trucks to experience SLA violations (e.g., throughput, latency, and/or packet loss, etc.), which may further escalate into equipment stoppages for each of the trucks. According to at least one example embodiment, the AAR Guidance service may compute and/or calculate PST instances for at least one future time period which may assign full-rate UL transmission opportunities for the gateways of only five of the six trucks, while the sixth truck is forced to drop its frame, thereby congestion in the cell is avoided, and five of the six trucks may continue operating as usual, with only the sixth truck affected by the SLA violation, thereby reducing and/or minimizing the number of SLA violations experienced by the entire system. Further, depending on the geolocation of the trucks, the AAR Guidance service may decide to evenly distribute a transmission rate penalty among the six trucks, or concentrate the transmission rate penalty to a subset of the trucks, such as a truck which has almost reached its destination, a truck which has almost reached a location with good channel quality, etc. Additionally, or alternatively, the AAR Guidance service may compute and/or calculate the PST instances for the at least one future time period by adjusting at least one setting (e.g., at least one OT application setting, etc.) associated with the at least one application in response to the SLA violation, etc. For example, the AAR Guidance service may reduce the bit rate setting of the video data of the truck, reduce the LiDAR resolution, reduce the frame rate(s) of the video and/or LiDAR, etc., in order to avoid the SLA violation, etc.

Additionally, the AAR Guidance service may compute the PST periodically and/or on demand, and distribute the PST to each of the gateways of the WCDs 120A to 120C. The AAR Guidance service may compute the PST such that the throughput of each PST instance is lower than the total capacity of the corresponding wireless communication channel(s) (e.g., wireless link, DRB, etc.). Consequently, the UL transmission packets that are transmitted from the UL application queues to the wireless modem of the WCDs 120A to 120C experience a reduced and/or minimal queueing latency in the modem, and the order of transmission of UL packets is controlled by a gateway scheduler of the WCDs 120A to 120C, thereby ensuring that the queuing latency of the UL packets is dominated by the sojourn time in the UL application queues of the UL gateways.

According to some example embodiments, the AAR Guidance service may use an algorithm, such as a Worst-Case Fair Weighted-Fair Queueing (WF2Q) algorithm, for assigning timeslots to the UL application queues according to their reserved service rates, under the assumption that all UL application queues always have packets to transmit and all packets have identical size, but the example embodiments are not limited thereto, and for example, other algorithms may be implemented.

Further, the AAR Guidance service may synchronize, e.g., time-synchronize, the PST schedules across all of the WCDs, e.g. WCDs 120A to 120C, etc., that are being served by the same cell, e.g., RAN node 110, etc., based on a time reference that is provided by the RAN node 110. According to some example embodiments, the AAR Guidance service may synchronize the PST scheduling of all of the WCDs 120A to 120C, etc., up to a desired synchronization time period, e.g., 500 microseconds, but the example embodiments are not limited thereto. As a first example, the AAR Guidance service may use real time kinematics (RTK) GPS synchronization to synchronize the modems of each of the WCDs to the desired synchronization time period. As a second example, the AAR Guidance service may use the precision time protocol (PTP) to synchronize the modems of each of the WCDs to the desired synchronization time period. As a third example, the AAR Guidance service may perform per-WCD (e.g., per-UE, etc.) adjustments of the scheduling time alignments of the WCDs 120A to 120C. More specifically, the AAR Guidance service may compare the expected UL transmission times for a WCD based on the scheduling of the PST and the actual times that the UL data was received from the WCD, and may re-align and/or shift the timing of the timeslots for the WCD for the next PST instance based on the timing difference between the expected UL transmission times and the actual transmission times, etc. However, the example embodiments are not limited thereto, and the AAR Guidance service may synchronize the PST scheduling of the WCDs 120A to 120C using alternative algorithms, etc.

According to some example embodiments, the AAR Guidance service may recompute, recalculate, update, modify, etc., the PST instance at a frequency that is sufficient to predictively take into account the channel conditions (e.g., the network device-measured network conditions, the network device-measured KPMs, etc.) of the individual WCDs 120A to 120C, the network congestion level experienced in each cell by each priority class (e.g., MC/BC priority classes, etc.), and/or the SLAs of the MC and/or BC applications that are being executed on the WCDs attached to the RAN node 110, etc. For example, the PST may be recalculated and/or updated based on one or more settings of the OT applications, such as a video-frame or group-of frame frequency (e.g., 30 frames per second video frame frequency), which would cause the PST to be recalculated every 33 ms, etc., but the example embodiments are not limited thereto.

In at least one example embodiment, the AAR Guidance service may recalculate and/or update the PST in response to a change in the UL traffic pattern due to a change in a setting of the application, such as a change in the bit-rate video resolution, etc. In other words, the AAR Guidance service may make an on-demand change due to a request and/or instruction from the OT operational control 130. In another example embodiment, the AAR Guidance service may recalculate and/or update the PST in response to at least one wireless communication channel capacity of at least one WCD changes significantly, e.g., the change in wireless communication channel capacity exceeds a desired change in capacity threshold, but is not limited thereto. For example, the desired capacity threshold may be based on the aggregate throughput of a current PST installed on and/or configured on each of the WCDs 120A to 120C, and the PST may be recalculated when the wireless communication channel capacity becomes less than the aggregate throughput of the current PST, etc. In other example embodiments, the frequency of the periodic PST calculations and/or updates may also be based on a time scope and accuracy of the sensors used for predicting the WCD channel conditions, the overall cell congestion, and/or the number of active flows of MC/BC applications, etc., but the example embodiments are not limited thereto. The PST will be discussed in greater detail in connection with FIGS. 3 to 5.

Additionally, according to some example embodiments, the modem of each of the WCDs 120A to 120C may establish a single Best-Effort wireless communication channel for both MC/BC and non-MC/BC traffic. In other example embodiments, the modem of each of the WCDs 120A to 120C may establish two or more wireless communication channels, e.g., a priority wireless communication channel for MC/BC traffic and a non-priority wireless communication channel for non-MC/BC traffic, etc. The PST schedules may include quotas for the queues of non-MC/BC traffic, but is not limited thereto.

The RAN operational control network node 140 may also identify the wireless communication channel carrying MC/BC data traffic based on the IPP of the wireless communication channel, and may map identifiers for the insight services to the RAN identifiers, such as cell radio network temporary identifier (CRNTI), a UE_ID_CU identifier, and/or logical channel ID (LCID) identifier, etc., but is not limited thereto. Accordingly, data traffic for registered OT control applications may be properly identified by the RAN Control 140 even if the IP address associated with the WCD changes due to, for example, network address translation (NAT) performed by the UPF, etc.

The RAN operational control network node 140 may generate a dynamic network map, such as a geo-location-based KPM heatmap, which may include and/or indicate network condition information and/or network performance information (e.g., serving cell channel quality, cell congestion, throughput, latency, etc.) corresponding to a geographic area served by the RAN node 110 and/or the wireless network, etc., wherein the network condition and/or network performance information may be collected from the WCDs 120A to 120C located within the geographic area and averaged over a desired sliding time window. The network condition and/or network performance information may also be collected/computed by the AAR RAN KPM predictor from CU/DU data for the WCDs located in the area.

According to at least one example embodiment, the dynamic network map may correspond to a geographic territory associated with the wireless network (e.g., the serving area of the RAN node 110, etc.). The geographic territory may be divided into a plurality of geographic pixels (e.g., units of geographic areas represented on the network map) wherein each geographic pixel is a three-dimensional (3D) cube with, e.g., an X-axis side representing a latitude coordinate, a Y-axis side representing a longitudinal coordinate, and a Z-axis side representing an altitude, but the example embodiments are not limited thereto. The size of each pixel (and/or the length of each side of the pixel) may be selected based upon the sensitivity of the available location sensors (e.g., GPS positioning sensor and altimeter used by the WCD 120A) which mapped the corresponding geographic area. Each pixel may contain information which indicates the network performance information collected by at least one WCD, e.g., WCD 120A, at the geographic location, and may be averaged over all WCDs, e.g., WCD 120A to WCD 120C, etc., which traveled over the geographic location corresponding to the pixel during a desired sliding time window, but the example embodiments are not limited thereto. For example, each pixel may include information regarding at least one of: serving cell congestion information corresponding to the 3D geographic area of the pixel, UL channel performance metric information corresponding to the 3D geographic area of the pixel as measured for the serving cell, and/or probability of the at least one network device being served by a particular serving cell corresponding to the 3D geographic area of the pixel, etc., but is not limited thereto. Each pixel may be color coded to indicate the level of network congestion and/or network condition of the geographic area corresponding to the pixel. Additionally, according to some example embodiments, the current location (or most recent) location of each WCD in the geographic area may be represented on the relevant pixel of the dynamic network map, and a predicted and/or future path or trajectory of travel may be indicated on the dynamic network map, but the example embodiments are not limited thereto. Moreover, the locations of stationary and/or mobile RAN nodes may also be illustrated on the dynamic network map, but the example embodiments are not limited thereto. According to some example embodiments, the dynamic network map may be implemented as a visual map, but the example embodiments are not limited thereto, and for example, the corresponding KPM information correlated to geographic locations may be stored as data in a table, a database, etc.

The RAN operational control network node 140 may also perform SLA aware trajectory planning assistance for the OT control network node 130, and more specifically, generating a prediction map of SLA-assurance which displays SLA violation probability information correlated to geographic locations along the predicted and/or future trajectory and/or path of travel for a future time period for each of the WCDs 120A to 120C, and may generate recommendations and/or instructions for the WCDs 120A to 120C regarding alternate paths and/or adjustment of the current path to avoid detrimental network conditions, etc. Further, the RAN operational control network node 140 may display the current location and the future trajectory of the WCDs on the dynamic network map, but the example embodiments are not limited thereto. The RAN operational control network node 140 may also perform enhanced localization service and provide network-assisted positioning service of the WCDs 120A to 120C to complement the location information provided by the WCDs 120A to 120C, etc. The RAN operational control network node 140 may also perform RAN function customization such as enhancing RAN functions and/or customizing RAN functions to a specific cell environment based on WCD-derived data, such as channel state information (CSI) compression and/or channel estimation functions, etc.

The RAN operational control network node 140 may also provide a communication endpoint for enforcing DU/CU radio resource allocation changes, adjustments, and/or optimization, including proactive handover configuration for one or more of the WCDs 120A to 120C based on the dynamic network maps, location information of the WCDs 120A to 120C, etc. The proactive handover configuration may be beneficial in circumstances such as when a wirelessly controlled truck is turning around a corner and its wireless signals may be blocked by another truck traveling towards it in an opposite lane, etc.

According to some example embodiments, the RAN operational control network node 140 may be co-located with the RAN node 110, but is not limited thereto. For example, in other example embodiments, the RAN operational control network node 140 may be hosted within an Open Radio Access Network (O-RAN) defined RAN intelligent controller (RIC) and service management and orchestration (SMO) platform, such as a near-real time RIC and/or a non-real time RIC, etc., a virtual RAN network node, a cloud RAN network node, a virtual RAN cloud network node, etc., but is not limited thereto. As another example, the RAN operational control network node 140 may be implemented within a plurality of network nodes, such as a near-real time RIC and a non-real time RIC, wherein the services of the RAN operational control network node 140 are split between the near-real time RIC and the non-real time RIC, but is not limited thereto. Further, the non-real-time RIC may communicate with CU/DU of the RAN node 110 over an O1 interface for RAN data exposure and control, the near-real-time RIC may communicate with CU/DU of the RAN node 110 over an E2 interface for data exposure and control, and the near-real time RIC and the non-real time RIC may communicate over an interface, such as an O-RAN A1 interface, etc., but the example embodiments are not limited thereto. In at least one example embodiment, the RAN insight service may be an O-RAN defined Service Management and Orchestration (SMO) Data and/or Services Exposure Function.

While certain components of a wireless communication network are shown as part of the wireless communication system of FIG. 1, the example embodiments are not limited thereto, and the wireless communication network may include components other than those shown in FIG. 1, which are desired, necessary, and/or beneficial for operation of the underlying networks within the wireless communication system, such as access points, switches, routers, nodes, servers, gateways, etc.

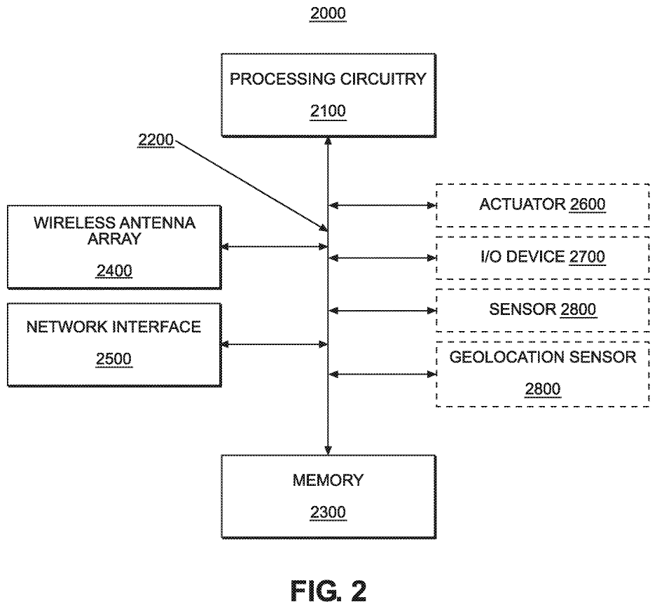

FIG. 2 illustrates a block diagram of an example network device and/or network node according to at least one example embodiment. The network device of FIG. 2 may correspond to a network node, such as the RAN node 110, the OT control network node 130, and/or the RAN operational control network node 140, etc., and/or a network device corresponding to one or more of the WCDs 120A to 120C of FIG. 1, but the example embodiments are not limited thereto.

Referring to FIG. 2, a network device 2000 (and/or a network node, etc.) may include processing circuitry, such as processing circuitry 2100, at least one communication bus 2200, a memory 2300, at least one wireless antenna array 2400, and/or at least one network interface 2500 (e.g., a private network interface, a core network interface, etc.), etc., but the example embodiments are not limited thereto. For example, the wireless antenna array 2400 and the network interface 2500 may be combined into a single network interface, etc., or the network device 2000 may include a plurality of wireless antenna arrays, a plurality of network interfaces, etc., and/or any combinations thereof. The memory 2300 may include various special purpose program code including computer executable instructions for performing the operations of FIGS. 3 to 5, etc., which may cause the network device 2000 to perform the one or more of the methods of the example embodiments, but the example embodiments are not limited thereto.

In at least one example embodiment, the processing circuitry 2100 may include at least one processor (and/or processor cores, distributed processors, networked processors, application processors, etc.), which may be configured to control one or more elements of the network device 2000, and thereby cause the network device 2000 to perform various operations. The processing circuitry 2100 is configured to execute processes by retrieving special purpose program code (e.g., special purpose computer readable instructions) corresponding to one or more operations of one or more methods described herein and data from the memory 2300 to process them, thereby executing special purpose control and functions of the entire network device 2000. Once the special purpose program instructions are loaded into the processing circuitry 2100, the processing circuitry 2100 executes the special purpose program instructions, thereby transforming the processing circuitry 2100 into a special purpose processor. According to some example embodiments, the processing circuitry 2100 may include a specially programmed FPGA, a special purpose system-on-chip (SoC), a special purpose ASIC, etc., which is specifically provided to perform the functionality related to one or more operations of the methods of FIGS. 3 to 5, etc., but the example embodiments are not limited thereto.

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the network device 2000, such as the methods discussed in connection with FIGS. 3 to 5, the at least one network interface 2500, the at least one wireless antenna array 2400, etc. Such software elements may be loaded from a non-transitory computer-readable storage medium independent of the memory 2300, using a drive mechanism (not shown) connected to the network device 2000, or via the at least one network interface 2500, and/or at least one wireless antenna array 2400, etc.

In at least one example embodiment, the communication bus 2200 may enable communication and data transmission to be performed between elements of the network device 2000. The bus 2200 may be implemented using a high-speed serial bus, a parallel bus, and/or any other appropriate communication technology. According to at least one example embodiment, the network device 2000 may include a plurality of communication buses (not shown), such as an address bus, a data bus, etc.

Additionally, according to some example embodiments, the network device 2000 may also operate as a RAN node, for example, a 4G RAN node, a 5G RAN node, a 6G RAN node, a 7G RAN node, a Wi-Fi base station, etc., for any UE devices and/or WCDs within wireless range of the network node, but the example embodiments are not limited thereto. Moreover, the network device 2000 may operate as an OT control network node 130, a RAN operational control network node 140, etc., but the example embodiments are not limited thereto.

According to other example embodiments, the network device 2000 may operate as a WCD (e.g., a robot, an industrial sensor, an AGV, a UAV, etc.) and may further include at least one actuator 2600, at least one input/output (I/O) device 2700 (e.g., a touchscreen, a microphone, a camera, a keyboard, a mouse, a camera, a speaker, etc.), at least one sensor 2800 (proximity sensors (e.g., an infra-red proximity sensor, a radar sensor, a LIDAR sensor, etc.), thermometers, humidity sensors, pressure sensors, motion sensors, accelerometers, cameras, computer vision cameras, etc.), and/or geo-location sensor (e.g., GPS, etc.), but is not limited thereto. According to some example embodiments, the WCD may also include at least one battery (not shown), a display panel, etc., but the example embodiments are not limited thereto.

The network device 2000 may also include at least one network interface 2500, and/or at least one wireless antenna array 2400, etc. The at least one wireless antenna array 2400 may include an associated array of radio units (not shown) and may be used to transmit the wireless signals in accordance with a radio access technology, such as 4G LTE wireless signals, 5G NR wireless signals, RFID wireless signals, Bluetooth wireless signals, WiFi wireless signals, etc., to at least one WCD and/or UE device, such as the WCDs 120A to 120C, etc. According to some example embodiments, the wireless antenna array 2400 may be a single antenna, or may be a plurality of antennas, etc. For example, the wireless antenna array 2400 may be configured as a grid of beams (GoB) which transmits a plurality of beams in different directions, angles, frequencies, and/or with different delays, etc., but the example embodiments are not limited thereto.

The network device 2000 may communicate with a core network (e.g., a backend network, backhaul network, backbone network, a private network, a local area network (LAN), a WAN, Data Network, etc.) via the network interface 2500. The network interface 2500 may be a wired and/or wireless network interface and may enable the network device 2000 to communicate and/or transmit data to and/or from network devices on the backend network, such as neighboring network devices and/or network nodes (not shown), a core network gateway (not shown), a Data Network, such as the Internet, intranets, WANs, LANs, etc.

While FIG. 2 depicts an example embodiment of a network device 2000, the network devices are not limited thereto, and may include additional and/or alternative architectures that may be suitable for the purposes demonstrated.

FIG. 3 is a transmission diagram illustrating an example method for providing RAN-coordinated UE-enforced UL congestion mitigation according to at least one example embodiment. FIG. 4 is an example diagram of a packet scheduling template (PST) according to at least one example embodiment. While FIG. 3 depicts a single RAN node 110, a single WCD 120, a single OT control network node 130, and a single RAN operational control network node 140, the example embodiments are not limited thereto and there may be a plurality of RAN nodes 110, a plurality of WCDs 120, a plurality of OT control network nodes 130, and/or a plurality of RAN operational control network nodes 140, etc.

In operation S3010, an SLA registration for the WCD 120 and/or MC/BC OT control application identification procedure may be performed, but the example embodiments are not limited thereto. According to at least one example embodiment, the OT control network node 130 may obtain SLA information (e.g., the SLA requirements) associated with an OT control application. The OT control application may include at least one BC and/or MC control flow, and accordingly the SLA requirements may differ for the control flows, but the example embodiments are not limited thereto. The OT control network node 130 may define and/or assign a unique identification pulse profile (IPP) to the OT control application and may transmit the unique IPP to the WCD 120. According to some example embodiments, the unique IPP may define a unique data burst transmission pattern for transmitting UL data from the WCD 120 to the RAN node 110 in a defined unique manner which allows the RAN node 110 and/or the RAN operational control network node 140 to identify data packets associated with the OT control application and apply the relevant SLA information, but the example embodiments are not limited thereto. According to at least one example embodiment, the IPP may specify a transmission time window of a desired length (e.g., 50 ms, etc.), specify subinterval transmission periods of desired lengths (e.g., 10 ms, etc.), and the desired amount of data to transmit within each subinterval, but is not limited thereto. For example, a first IPP may uniquely define that the WCD 120 transmit 1 MB of data during a first subinterval, 0 MB of data during a second subinterval, and 2 MB of data during a third subinterval, on a first wireless communication channel associated with a first OT control application, but the example embodiments are not limited thereto. A second IPP may be uniquely defined for the WCD 120 for use on a second wireless communication channel associated with a second OT control application, such as transmitting 5 MB of data during the first subinterval, 5 MB of data during the second subinterval, and 0 MB of data during the third subinterval, thereby allowing the RAN node 110 and/or the RAN operational control network node 140 to determine that data received on the first wireless communication channel corresponds to the first OT control application and data received on the second wireless communication channel corresponds to the second OT control application, based on the transmission patterns of an identification pulse sent by the WCD 120, etc.

The WCD 120 may register and/or associate the IPP with the wireless communication channel (e.g., DRB, etc.) being used to transmit/receive data related to the OT control application as well as the SLA information related to the OT control application and the wireless communication channel associated with the OT control application, but the example embodiments are not limited thereto. The OT control network node 130 may register the IPP and the SLA information associated with the OT control application and the associated wireless communication channel with the RAN operational control network node 140 (e.g., the RAN insight service, etc.), and the OP control network node 130 may forward and/or make available the IPP and SLA information to the AAR KPM, etc.

In operation S3020, the OT control network node 130 and the WCD 120 may engage in a communication session (e.g., UL and DL) using a wireless communication channel via the RAN node 110, etc., but the example embodiments are not limited thereto. For example, the OT control network node 130 may define bitrate resolutions and/or view angle widths of video cameras, LiDAR resolution, and/or data sensor report frequencies and/or volumes, etc., but is not limited thereto. Additionally, the WCD 120 may transmit its current location information and/or WCD-measured network performance information (e.g., network device-measured KPMs, etc.) to the OT control network node 130, but is not limited thereto. For example, the WCD-measured network performance information may include at least one of: UL channel quality information, current network resource allocation information, downlink (DL) channel quality measurement information, UL queuing latency information, etc., but is not limited thereto.

Additionally, the OT control network node 130 may calculate and/or predict the future location information (e.g., the future path and/or travel trajectory) of the WCD 120 for a future time period. For example, the future location information may include a plurality of geographic coordinates (e.g., a sequence of geographic coordinates) that the WCD 120 is predicted to travel along during the future time period, etc. The OT control network node 130 may transmit the future location information to the RAN operational control network node 140. Further, the OT control network node 130 may also predict network (e.g., MC/BC UL data traffic, etc.) traffic pattern information for the future time period based on OT application settings (e.g., operational control settings, etc.) assigned to and/or defined for the WCD 120, such as the bitrate resolutions and/or view angle widths of video cameras, a LiDAR resolution setting, and/or data sensor report frequencies and/or volumes, etc., and may transmit the predicted network traffic pattern information to the RAN operational control network node 140, but is not limited thereto.

In operation S3040, the RAN node 110 may forward scheduling information (e.g., periodic fine granularity data reports, etc.) and/or radio link control (RLC) data for all wireless communication channels to the RAN operational control network node 140. The RLC data may include a sequence of numbers, each number representing the number of bytes of data that arrived to the uplink RLC during a fine granularity consecutive time bin. For example, if the time bin duration is 5 ms and the data reporting period is 2 seconds, the RLC report comprises 2000/5=400 bin numbers.

In operation S3050, the AAR RAN KPM predictor of the RAN operational control network node 140 may generate at least one digest based on the received scheduling information and/or RLC data for each of the wireless communication channels, the traffic profiles, and/or the current location information of the WCD 120, etc. For example, the AAR RAN KPM predictor may monitor and predict the RAN network performance information (e.g., the network-side KPMs, the RAN KPMs, etc.) for a future time period. The network performance information may include at least one of: UL cell congestion, UL UE channel metrics, UL latency, etc., but is not limited thereto. According to at least one example embodiment, the UL cell congestion metric may be calculated and/or computed to indicate a number of UL PRBs that are available to an ideal “very active” wireless flow and/or data radio bearer (e.g., DRB) that continuously has data to transmit in the uplink direction during each time period. In another example embodiment, the UE channel metric may be calculated and/or computed to indicate an average number of bytes per PRB that the uplink scheduler may pack using at least one selected modulation and coding scheme (MCS). In another example embodiment, the UE channel metric may be derived from the Sounding Reference Signal (SRS) exposed by the DU. In another example embodiment, the AAR RAN KPM predictor may predict the UL throughput for the WCD 120 (e.g., the UE, etc.) using the above congestion and/or channel metrics, etc., but is not limited thereto. In another example embodiment, the AAR RAN KPM predictor may predict an uplink latency from uplink throughput and the RLC data. Further, the AAR RAN KPM predictor may predict the SLA violation probability for each of the MC and/or BC traffic flows based on the current PST. Additionally, the AAR RAN KPM predictor may use a network map to predict SLA violations. The AAR RAN KPM predictor may also determine observed time gaps between RLC reported data arrival bursts and expected times of the respective data bursts according to the previous PST, and may use the calculated time gaps to make relative time synchronization adjustments in the next PST for a future time period (e.g., a next time period) for the WCDs, but the example embodiments are not limited thereto, and time synchronization adjustments may be performed using other methods, such as RTK GPS synchronization, PTP synchronization, etc.

In operation S3060, the AAR RAN KPM predictor may send the predicted KPMs for each MC/BC wireless communication channel to the AAR Guidance service, but is not limited thereto. In operation S3070, the RAN operational control network node 140 (and/or the AAR Guidance service) may calculate and/or compute the PST schedules for all of the WCDs being served by the RAN node 110 based on the current location information of the WCDs, the MC/BC traffic profiles, the predicted KPMs, and/or the predicted SLA violation probabilities, etc., but is not limited thereto. The RAN operational control network node 140 may also designate at least one virtual empty queue for the RAN node 110, and may assign the at least one virtual empty queue with a packet service rate equal to the difference between the current transmission capacity of the cell (e.g., the packet rate, etc.) and the sum of the packet service rates allocated to all of the UL application queues. Additionally, the AAR RAN KPM predictor may determine whether the predicted SLA violation probability for a future time period (e.g., the next time period, the next PST interval, etc.) for each of the OT applications exceeds a desired SLA violation probability threshold. For example, if the predicted SLA violation probability for a first OT application exceeds the desired SLA violation probability threshold, the AAR RAN KPM predictor may adjust the PST for the future time period such that time slots that were previously associated with one or more virtual empty queues in the PST are assigned to the application queue associated with the first OT application, if the virtual empty queues are available. However, if no time slots associated with the virtual empty queues are available, or if the packet service rates of the time slots associated with the virtual empty queues are not sufficient to cure the predicted SLA violation, the AAR RAN KPM predictor may instruct the OPM control network node 130 to adjust at least one setting of the first OT application such that the SLA violation is avoided or minimized, etc.

More specifically, the RAN operational control network node 140 may assign a unique identifier for each UL application queue k for all of the WCDs being served by the RAN node 110 and may assign a normalized packet transmission rate rₖ for each UL application queue as well. The packet transmission rate rₖ may be set based on the SLA requirements associated with the OT application associated with the respective UL application queue. According to at least one example embodiment, the packet transmission rates rₖ for all of the UL application queues are set such that the sum of the packet transmission rates and the rate of the virtual empty queue rₒ is always equal to 1, e.g., Σᵢrᵢ=1. Each queue is also associated with a virtual start time Sₖ and a virtual finish time Fₖ=Sₖ+1/rₖ. The virtual finish time Fₖ defines the virtual transmission deadline of the packet at the head of the queue, while the virtual start time Sₖ defines the earliest virtual time that the transmission of the same packet can start. The RAN operational control network node 140 performs calculation of the PST one timeslot at a time. Every scheduling decision fills a corresponding timeslot in the PST. At timeslot n, the RAN operational control network node 140 (e.g., the AAR Guidance service) selects the queue k(n) with the minimum virtual finish time within the set ε of queues whose virtual start time is not greater than

$$n : {F}_{k ( n )} = {min}_{j ∈ ε} \{ {F}_{j} : {S}_{j} \leq n \} .$$

Every time a queue k is selected for service, its virtual start and finish times are updated as follows: Sₖ=Fₖ, Fₖ=Sₖ+1/rₖ. At timeslot 0, when the PST computation starts, the virtual start and finish times are initialized as follows: Sₖ=0, Fₖ=1/rₖ.

Moreover, the RAN operational control network node 140 may compute the PST schedules for every MC and/or BC application queue for every WCD served by the RAN node 110, and the PST generated may include the scheduling for every application queue for every WCD, etc., but the example embodiments are not limited thereto.

In operation S3080, the RAN operational control network node 140 may transmit the PST for the future time period to the OT control network node 130 and/or the AAR RAN KPM predictor for use in calculating the predicted network device KPMs, the predicted SLA violation probabilities, etc., for the next future time period, etc.

In operation S3090, the OT control network node 130 may transmit the PST to every WCD, but is not limited thereto. In operation S3100, each of the WCDs 120 may apply their respective PST schedules (or apply their respective portion of the PST schedule), etc., but the example embodiments are not limited thereto.

Now referring to FIG. 4, an example PST 410 for a future time period and/or a desired time interval and a plurality of UL application queues 420 are illustrated. The example PST 410 may include a plurality of timeslots, each timeslot associated with a different UL application queue 420. As shown in FIG. 4, the PST 410 includes a sequence of 16 timeslots corresponding to one of 10 UL application queues numbering from #1 to #10, and a single virtual empty queue indicated by a number #0, but the example embodiments are not limited thereto, and the PST may include a greater or lesser number of timeslots and/or a different number of UL application queues, etc. The PST 410 may indicate the order in which a PST scheduler of the WCD 120 may transfer UL data packets from the respective and/or corresponding UL application queue to the UL transmission queue of the modem of the WCD 120 for transmission to the RAN node 110 via an associated wireless communication channel (e.g., DRB, etc.). The number of timeslots for each UL application queue included in the PST 410 may vary based on the packet transmission rate assigned to the UL application queue by the RAN operational control network node 140, but the example embodiments are not limited thereto. For example, as shown in FIG. 4, the UL application queue #2 may be scheduled to transfer its data packets in four timeslots, e.g., the first timeslot, the fifth timeslot, the ninth timeslot, and the thirteenth timeslot, but is not limited thereto. The UL application queue #1 may be scheduled to transfer its data packets in a single timeslot, e.g., the fourth timeslot, etc. Further, virtual empty queue #0 may be scheduled for two timeslots in the PST 410, e.g., the eighth timeslot and the sixteenth timeslot, but is not limited thereto.

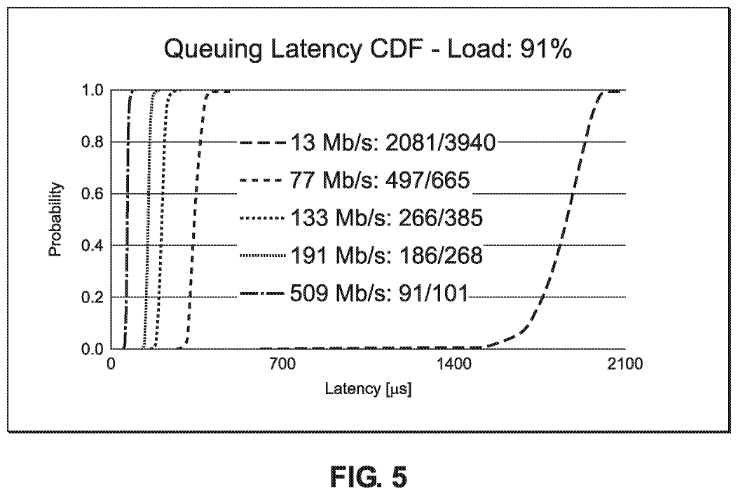

FIG. 5 is an example graph illustrating the effects on the SLA achieved by a PST scheduler according to at least one example embodiment.

More specifically, FIG. 5 illustrates the degree of SLA differentiation that a PST scheduler according to one or more example embodiments may achieve using traffic flows with different throughputs and latency requirements. The graph of FIG. 5 shows the cumulative distribution functions (CDF) and maximum values of the queueing latencies experienced by groups of traffic flows of five different types in a PST scheduler that controls a 25 Gb/s communication channel, e.g., a group of 13 Mb/s traffic flows, a group of 77 Mb/s traffic flows, a group of 133 Mb/s traffic flows, a group of 191 Mb/s traffic flows, and a group of 509 Mb/s traffic flows, but the example embodiments are not limited thereto. As shown in the legend of FIG. 5, the fractions associated with each group of traffic flows indicates the ratio between the maximum latency measured for each group and the corresponding theoretical maximum latency bound which is inversely proportional to the guaranteed service rate of the traffic flows in the group. The graph of FIG. 5 shows that the PST scheduler of one or more example embodiments consistently enforces compliance of the maximum latencies with the respective bounds, and also illustrates the ability of the PST scheduler to enforce SLA differentiation among the groups of traffic flows.

Through the descriptions of the preceding implementations, the subject matter disclosed may be implemented by using hardware only, or by using software and a necessary hardware platform, or by a combination of hardware and software. The coding of software for carrying out the above-described methods described is within the scope of a person of ordinary skill in the art having regard to the present disclosure. Based on such understandings, the technical solution of the subject matter disclosed herein may be embodied in the form of a software product. The software product may be stored in a non-volatile or non-transitory storage medium, which may be, for example, an optical storage medium, flash drive, a hard disk, a solid-state drive, a universal serial bus (USB) drive, etc. The software program or product (otherwise referred to as a computer program or computer product) includes instructions that enable a computing device (e.g., a user equipment or a core network apparatus as described herein) to execute the methods provided in the implementations of the present disclosure.

The operations (otherwise referred to as steps) of the methods shown in the flowcharts in the drawings and described herein are for purposes of illustration only. There may be many variations to these operations or steps without departing from the scope of the present disclosure. For instance, the operations may be performed in a differing order, or operations may be added, deleted, or modified, as appropriate.

It is anticipated that features from one or more of the above-described implementations may be selected to create alternate implementations comprised of a sub-combination of features which may not be explicitly described above. In addition, features from one or more of the above-described implementations may be selected and combined to create alternate implementations comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example implementations described herein. It will, however, be understood by those of ordinary skill in the art that the example implementations described herein may be practiced without these specific details. Furthermore, well-known methods, procedures, and elements have not been described in detail so as not to obscure the example implementations described herein. The subject matter described herein and in the recited claims intends to cover and embrace all suitable changes in technology.

Although the subject matter disclosed herein and some of its advantages (e.g., technological improvements) have been described in detail, other advantages (e.g., other technological improvements) may be apparent from the present disclosure. It should be understood that various changes, substitutions and alterations can be made to the subject matter disclosed herein without departing from the scope of the present disclosure as defined by the appended claims.

The subject matter disclosed herein may be embodied or implemented in other specific forms without departing from the scope of the claims. The described example implementations are to be considered in all respects as being only illustrative and not restrictive. The subject matter disclosed herein intends to cover and embrace all suitable changes in technology. The scope of the present disclosure is, therefore, described by the appended claims rather than by the foregoing description. The scope of the claims should not be limited by the implementations set forth in the examples or implementations described herein but should be given the broadest interpretation consistent with the description as a whole.

What is claimed is:

1. A network node comprising:
memory storing computer readable instructions; and
processing circuitry configured to execute the computer readable instructions to cause the network node to,
obtain location information associated with at least one network device, and uplink (UL) data traffic pattern information from the at least one network device over at least one wireless communication channel associated with at least one application executed by the at least one network device,
calculate network performance information associated with the at least one wireless communication channel associated with the at least one network device for a future time period based on the location information and the UL data traffic pattern information,
calculate service level agreement (SLA) compliance information for the at least one application corresponding to the future time period based on the network performance information associated with the at least one wireless communication channel,
determine a packet scheduling template for each network device of the at least one network device based on the calculated SLA compliance information and the UL data traffic information; and
transmit the packet scheduling template to each network device of the at least one network device.

2. The network node of claim 1, wherein
the packet scheduling template includes a plurality of time slots;
each time slot of the plurality of time slots is associated with a respective application of the at least one application executed by the at least one network device; and
the packet scheduling template causes the at least one network device to,
transfer UL packets stored in an application queue associated with the respective application to a UL transmission queue during the time slot associated with the respective application, and
transmit the UL packets stored in the UL transmission queue to a radio access network (RAN) node based on a UL transmission schedule obtained from the RAN node.

3. The network node of claim 2, wherein
each time slot of the plurality of time slots is associated with a mission-critical (MC) application, a business-critical (BC) application, a non-MC/BC application, or a virtual empty queue.

4. The network node of claim 3, wherein the network node is further caused to calculate the SLA compliance information for the at least one application corresponding to the future time period by:
predicting an SLA violation probability for the at least one application corresponding to the future time period based on the network performance information associated with the at least one wireless communication channel and the packet scheduling template; and
in response to the SLA violation probability exceeding a threshold SLA violation probability,
adjusting the packet scheduling template such that at least one additional time slot of the packet scheduling template is assigned to the at least one application whose SLA violation probability exceeds the threshold SLA violation probability in response to at least one time slot assigned to the virtual empty queue being available, or
adjusting at least one setting associated with the at least one application whose SLA violation probability exceeds the threshold SLA violation probability.

5. The network node of claim 4, wherein the network node is further caused to determine the packet scheduling template by:
determining a current transmission capacity of the least one wireless communication channel for the future time period based on the calculated network performance information associated with the at least one wireless communication channel;
determining a total desired packet transmission rate for all of the at least one application corresponding to the future time period based on the calculated SLA compliance information for the at least one application; and
assigning the time slots of the packet scheduling template to the at least one application queue based on the determined current transmission capacity and the total desired packet transmission rate.

6. The network node of claim 5, wherein the network node is further caused to determine the packet scheduling template by:
determining the packet scheduling template using a Worst-Case Fair Weighted-Fair Queueing algorithm.

7. The network node of claim 6, wherein the network node is further caused to:
update the packet scheduling template based on at least one setting associated with the at least one application executed by the at least one network device.

8. The network node of claim 7, wherein the network node is further caused to:
update the packet scheduling template in response to a modification to the UL data traffic pattern information.

9. The network node of claim 8, wherein the network node is further caused to:
update the packet scheduling template in response to a modification to network resources allocated to the at least one wireless communication channel.

10. The network node of claim 9, wherein
the at least one network device is a plurality of network devices; and
the network node is further caused to,
synchronize time across the plurality of network devices.

11. The network node of claim 10, wherein the network node is further caused to perform the synchronization of time across the plurality of network devices by using at least one of:
real time kinematics GPS synchronization, a precision time protocol, a per-network device time adjustment, or any combinations thereof.

12. The network node of claim 11, wherein the network node is further caused to use the per-network device time adjustment by:
determining a scheduling time alignment by comparing a time at which UL data was received from a desired network device of the plurality of network devices to a scheduled UL transmission time for the desired network device according to the packet scheduling template.

13. The network node of claim 12, wherein the network performance information includes at least one of:
UL cell congestion information, UL network device channel metric information, UL latency information, UL throughput information, or any combinations thereof, associated with the at least one wireless communication channel for the future time period.

14. The network node of claim 13, wherein the network node is at least one of:
a near-real time RAN intelligent controller (RIC), a non-real time RIC, a RAN node, a virtual RAN, a cloud RAN, or any combinations thereof.

15. A network device comprising:
memory storing computer readable instructions; and
processing circuitry configured to execute the computer readable instructions to cause the network device to,
transmit current location information to a network controller,
execute a plurality of applications, each application of the plurality of applications associated with a wireless communication channel,
receive a packet scheduling template from a network node, the packet scheduling template including a plurality of time slots, each time slot of the plurality of time slots associated with a respective application executed by the network device,
transfer uplink (UL) packets stored in at least one application queue associated with the respective application to a UL transmission queue during the time slot associated with the respective application, and
transmit the UL packets stored in the UL transmission queue to a radio access network (RAN) node based on a UL transmission schedule obtained from the RAN node.

16. The network device of claim 15, wherein
each time slot of the plurality of time slots is associated with a mission-critical (MC) application, a business-critical (BC) application, a non-MC/BC application, or a virtual empty queue.

17. The network device of claim 16, wherein
every time slot of the plurality of time slots corresponds to a same duration of time.

18. The network device of claim 17, wherein the network device further includes a plurality of application queues, each of the application queues corresponding to a respective application of the plurality of applications, the plurality of application queues including the at least one application queue.

19. The network device of claim 18, wherein the network device is further caused to:
measure network performance information associated with the wireless communication channel; and
transmit the measured network performance information to the network controller, the measured network performance information enabling the network node to generate the packet scheduling template.

20. The network device of claim 19, wherein the measured network performance information includes at least one of:
current network resource allocation information, downlink (DL) channel quality measurement information, UL queuing latency information, or any combinations thereof.
